(19) United States
(12) Patent Application Publication
(10) Pub. No.: US 2013/0070955 A1
(43) Pub. Date: Mar. 21, 2013

(54) LOUDSPEAKER WITH INTERLOCKING MAGNET STRUCTURE

(71) Applicant: Harman International Industries Ltd., Hertfordshire (GB)

(72) Inventors: Andrew Holt, Cumbria (GB); Stuart Hancock, Swansea (GB)

(73) Assignee: Harman International Industries Ltd., Hertfordshire (GB)

(21) Appl. No.: 13/677,955

(22) Filed: Nov. 15, 2012

Related U.S. Application Data
(63) Continuation of application No. PCT/EP2011/057051, filed on May 3, 2011.

(30) Foreign Application Priority Data
May 20, 2010 (EP) 10163414.5

(51) Int. Cl. H04R 3/00

(52) U.S. Cl. CPC H04R 3/00
USPC 381/412; 381/396

(57) ABSTRACT

A loudspeaker having a magnet system and a method of assembling the magnet system are disclosed. The magnet system comprises a magnet and an armature core that is mounted on the magnet. The magnet system also includes a shell pot configured to receive the magnet and the armature core in a hollow interior. The magnet system further includes a shaft that interlocks with the magnet, the armature core and the shell pot, and that is, on one end, mechanically connected to the shell pot. The magnet system also includes a push-on fastener that has an aperture through which the shaft passes and that is secured to the shaft at another end of the shaft such that it applies pressure onto the first surface of the armature core to fixedly position the armature core and the magnet with respect to the shell pot.

### PRIORITY CLAIM

This application is a continuation of PCT Application Serial No. PCT/EP2011/057051, filed May 3, 2011, entitled “LOUDSPEAKER WITH INTERLOCKING MAGNET STRUCTURE,” and which claims the benefit of priority from European Patent Application No. EP 10163414.5 filed May 20, 2010, each of which is incorporated by reference in its entirety.

### BACKGROUND OF THE INVENTION

1. Technical Field

This invention relates to a loudspeaker and more particularly, to a loudspeaker with an interlocking magnet structure.

2. Related Art

A transducer is a device that converts one form of an input signal into another form. Loudspeakers are one example of a transducer. Loudspeakers convert electrical signals into sound. Loudspeakers include a diaphragm, a voice coil and a magnet system. The voice coil is attached to the diaphragm and disposed in an air gap of the magnet system such that it is capable of vibrating. The magnet system generates magnetic flux in the air gap. As current representing an audio signal flows through the voice coil, it creates an induced magnetic field that reacts with the magnetic flux in the air gap generated by the magnet system. This causes the voice coil and, accordingly, the diaphragm to move. As a result, sound is generated.

The magnet system may include, among other components, at least one permanent magnet, a ferromagnetic shell pot and, as the case may be, other ferromagnetic elements such as an armature core. During manufacturing of the magnet system, adhesives may be used to secure the positions of the permanent magnet, the armature core and the shell pot with respect to one another. The shell pot may be a housing that contains the permanent magnet and the armature core. For example, the shell pot may have cylindrical shape with a hollow interior. The permanent magnet may be disposed on the floor of the shell pot. The armature core is arranged on the magnet or between two magnets. Adhesive used in the magnet structure may be affected by the working environment of loudspeakers such as temperature fluctuations, wet conditions, etc.

To overcome the problems outlined above, Mihelich et al. propose, e.g., in U.S. Pat. No. 7,894,623, an interlocking magnet structure in which adhesives may be used to a lesser extent or even may not be used at all. The known interlocking mechanism provides relatively stable mechanical connections in the magnet structure. The manufacturing process is relatively simple and easy. However, there is still a general need for a magnet system with a structure that provides an adhesive-free interlocking mechanism allowing a more simplified manufacturing process and further reducing manufacturing expenses.

### SUMMARY

A loudspeaker is described herein that has a magnet system. The magnet system comprises a magnet that has a first surface, a second surface and an aperture. The magnet system can have an armature core that has a first surface, a second surface and an aperture and that is mounted on the magnet, where the second surface of the armature core contacts the first surface of the magnet. The magnet system can further include a shell pot configured to receive the magnet and the armature core in a hollow interior, where the second surface of the magnet contacts a base surface of the shell pot. The magnet system can also have a shaft that interlocks with the magnet, the armature core and the shell pot, that extends through the aligned apertures included in each of the magnet, the armature core and the shell pot, and that is, on one end, mechanically connected to the shell pot. The magnet system can include a push-on fastener that has an aperture through which the shaft passes and that is secured to the shaft at another end of the shaft such that it applies directly or indirectly pressure onto the first surface of the armature core to fixedly position the armature core and the magnet with respect to the shell pot.

Other features and advantages of the invention will be, or will become, apparent to one with skill in the art upon examination of the following figures and detailed description. It is intended that all such additional systems, methods, features and advantages be included within this description, be within the scope of the invention, and be protected by the following claims.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 illustrates a cross-sectional view of an example loudspeaker having a double-magnet interlocking magnet system.

FIG. 2 is a top view of the interlocking magnet system of FIG. 1.

FIG. 3 is a cross-sectional view of a first example of an interlocking magnet system for a single magnet type.

FIG. 4 illustrates a cross-sectional view of a second example of a single-magnet interlocking magnet system with a flange.

FIG. 5 illustrates a cross-sectional view of a second example of a double-magnet interlocking magnet system.

FIG. 6. illustrates a cross-sectional view of a third example of a double-magnet interlocking magnet structure.

FIG. 7 illustrates a cross-sectional view of an alternative of the single-magnet interlocking magnet system of FIG. 4.

FIG. 8 illustrates a cross-sectional view of an alternative of the double-magnet interlocking magnet structure of FIG. 6.

FIG. 9 is a side view of a first example of a push-on fastener that is applicable to the magnet systems shown in FIGS. 1-8.

FIG. 10 is a plan view of the push-on fastener shown in FIG. 9.

FIG. 11 is a cross-sectional view of the push-on fastener of FIG. 9 on line B-B.

FIG. 12 is a perspective view of a second example of a push-on fastener that is applicable to the magnet systems shown in FIGS. 1-8.

FIG. 13 is an end view of the push-on fastener shown in FIG. 12.

FIG. 14 is a side view of the push-on fastener shown in FIG. 12.

FIG. 15 is a plan view of a third example of a push-on fastener that is applicable to the magnet systems shown in FIGS. 1-8.

FIG. 16 is a cross-sectional view of the push-on fastener of FIG. 15 on line C-C.

FIG. 17 is a cross-sectional view of the push-on fastener of FIG. 15 on line D-D.

FIG. 18 is a side view of a fourth example of a push-on fastener that is applicable to the magnet systems shown in FIGS. 1-8.

FIG. 19 is a plan view of the push-on fastener shown in FIG. 18.

FIG. 20 is a cross-sectional view of the push-on fastener of FIG. 18

FIG. 21 is a side view of a fifth example of a push-on fastener that is applicable to the magnet systems shown in FIGS. 1-8.

FIG. 22 is a plan view of the push-on fastener shown in FIG. 21.

FIG. 23 is a cross-sectional view of the push-on fastener of FIG. 21.

### DETAILED DESCRIPTION

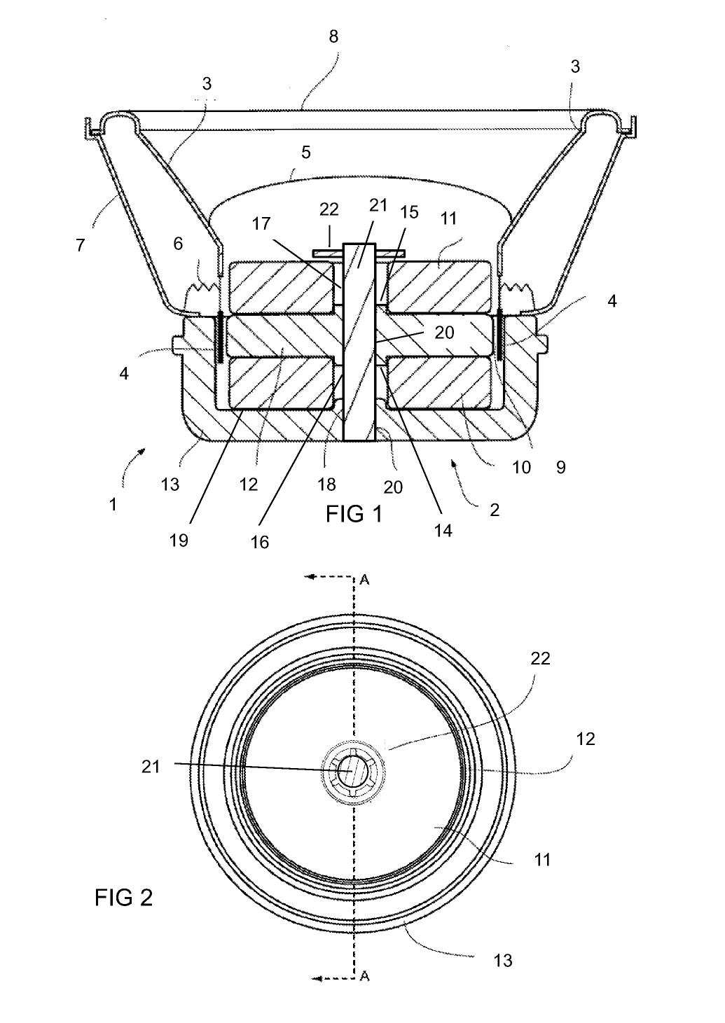

FIG. 1 illustrates an example loudspeaker 1 with a magnet system 2 which has an interlocking magnet structure. One end of a diaphragm 3 is attached to a voice coil 4. Close to this end, a dust cap 5 that keeps the loudspeaker 1 from dirt, dust, etc. is attached to the diaphragm 3 (or voice coil 4 or both). For example, the dust cap 5 is glued to the diaphragm 3. The diaphragm 3 is secured to the voice coil 4, and the voice coil 4 (or diaphragm 3 or both) is secured with a spider 6 to a frame 7 of the loudspeaker 1 directly or indirectly such as by means of at least one securing component. The other end of the diaphragm 3 is secured with a resilient surround 8 to an outer edge of the frame 7. The surround may be integral part of the diaphragm 3 (one piece diaphragm-surround assembly) or attached the diaphragm 3. The magnet system 2 is secured to the frame 7 and interacts with the voice coil 4 in an air gap 9 where the voice coil 4 is positioned. Elements such as diaphragms, voice coils, etc. are exemplary only and the loudspeaker 1 is not limited thereto. Operations of the loudspeaker 1 are not described here in detail.

The magnet system 2 has an interlocking magnet structure and includes two ring-shaped magnets 10 and 11. An armature core 12 is disposed between the magnet 10 and the magnet 12. The armature core 12 may be solid and one-piece. A shell pot 13 contains the magnet 10 in its hollow interior. The magnet 11 is disposed in a space above the shell pot 13. The armature core 12 has a nub 14 and a nub 15 that are protrusions that vertically extend along the central axis of the magnet system 2. The magnet 10 includes an aperture 16 and the magnet 11 includes an aperture 17. The magnet 10 interlocks with the nub 14 and the magnet 11 interlocks with the nub 15. The shell pot 13 has a central protrusion 18 perpendicularly extending from its base surface 19. The magnet 10 engages with the nub 14 of the armature core 12 and the protrusion 18 of the shell pot 13.

The magnet 11 further interlocks with the nub 15 of the armature core 12 in that the nub 15 engages with the aperture 17 of the magnet 11. The magnet 11 is mounted on the armature core 12 above the shell pot 13. The apertures 16, 17 of the magnets 10, 11 each have a diameter and the nubs 14, 15 each have a width whereby the diameter of an aperture 16, 17 may be substantially identical to or slightly greater than the width of the corresponding nub 14, 15, so that the nubs 14, 15 may locate precisely into the apertures 16, 17. A certain distance should be maintained between the nub 14 and the protrusion 18, to prevent a magnetic short circuit. Dimensions for the widths of the nubs 14, 15, the diameters of the apertures 16, 15 and the distance between the nub 14 and the protrusion 18 may vary depending on the size of the magnets 10 and 11, the type of material of the magnets 10 and 11, the strength of the magnetic flux from the magnets 10 and 11, the thickness of the armature core 12, etc.

In the magnet system 2 illustrated in FIG. 1, two permanent magnets 10 and 11 are substantially identical in size and shape. In other examples, magnets different in size and, as the case may be, in shape may be used. The diameters of the apertures 16, 17 may be identical or different and the widths of the nubs 14, 15 may vary accordingly. The apertures 16 and 17 may have a cylindrical shape, but they may also be tapered, or they may be rectangular shaped. The shape and size of the nubs 14, 15 and the protrusion 18 may be changed accordingly.

The magnet system 2 has the solid armature core 12 in which a passageway 20 is formed. The passageway 20 also penetrates the protrusion 18 and extends through the shell pot 13. In the passageway 20 a shaft 21 made from non-magnetic material such as, e.g., brass, aluminum, stainless steel or plastic is inserted. The shaft 21 is secured on its one end to the shell pot 13 and extends on the other end beyond the upper surface of magnet 11 where a push-on fastener 21 is pushed on the shaft 21 such that compressive force is applied to the magnets 10, 11 and the armature core 12 by fastener 22 and shell pot 13.

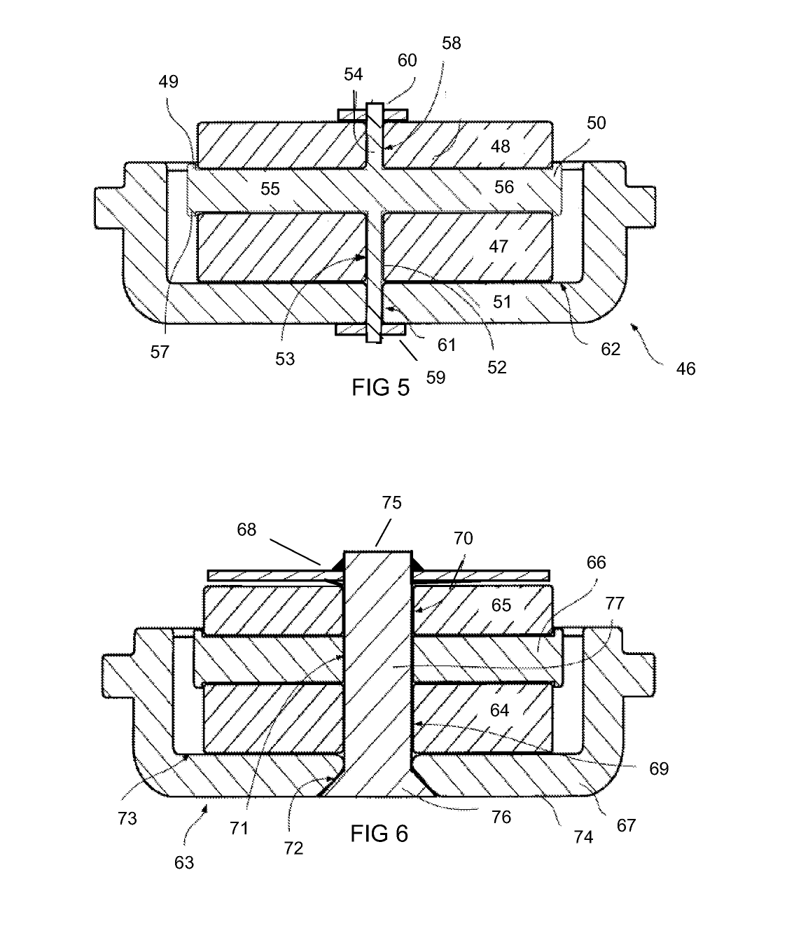

In FIG. 2, the assembled magnet system 2 as used in the loudspeaker of FIG. 1 is illustrated in a top view. FIG. 1 corresponds to a cross-sectional view along line A-A of FIG. 2. The outermost circle corresponds to the shell pot 13 and the middle circle corresponds to the armature core 12. The first magnet 10 is not shown in FIG. 5 because it is hidden beneath the armature core 12 and the second magnet 11. The second magnet 11 corresponds to the innermost circle. At the center, the shaft 21 is shown which enters the passageway 20 and engages with the fastener 22.

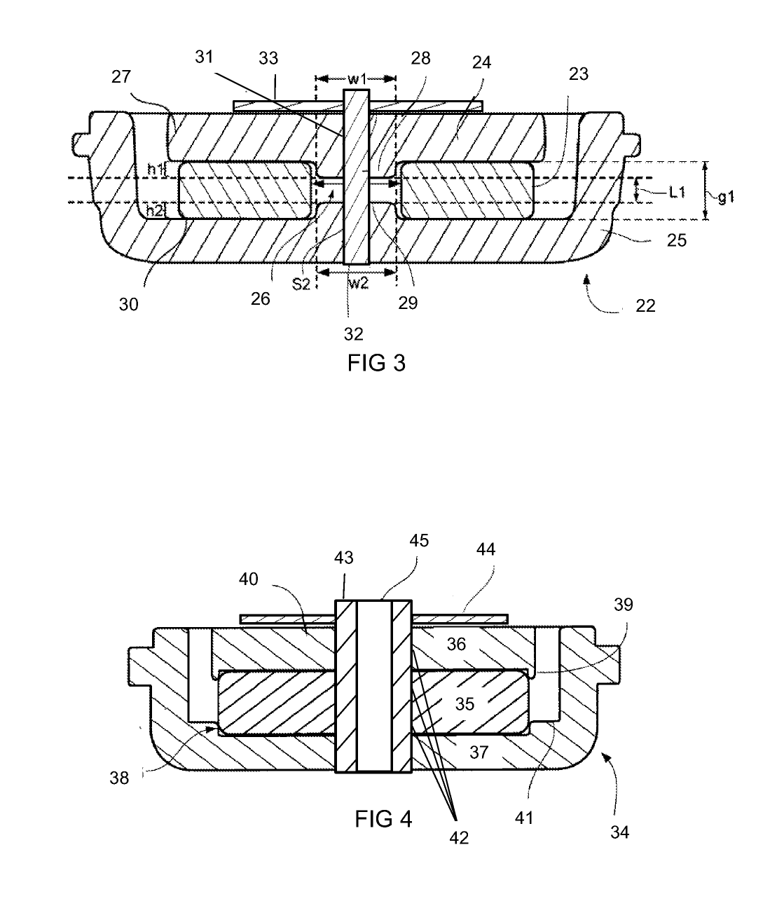

FIG. 3 illustrates an example of an interlocking magnet structure 22 for a single magnet type. The interlocking magnet structure 22 includes a permanent magnet 23, an armature core 24 and a shell pot 25 that are configured to interlock with one another. The magnet 23 may be made from various materials such as neodymium, ceramic, etc. The armature core 24 and the shell pot 25 may be made from ferromagnetic materials, such as iron, steel, etc. but are not limited thereto. In FIG. 3, the magnet 23 has a disc shape but may have any other shapes applicable. The magnet 23 is formed to define an aperture 26 in its center such as is ring-shaped. The aperture 26 has a diameter d1 and a depth g1. Length L1 is a distance between a surface S1 of the armature core 24 and a surface S2 of the shell pot 25. The length L1 is provided to avoid a magnetic short circuit.

An armature core 24 has a disc shape and is placed on the disc-shaped magnet 23. The armature core 24 includes a body member 27 and a nub 28. The nub 28 is a protrusion or lump extending a predetermined distance (h1) substantially perpendicular to the body member 27. The nub 28 has a width w1. The width w1 is substantially equal to or slightly smaller than the diameter d1. The nub 28 is inserted into the aperture 26 and upon insertion the magnet 23 is mechanically centered.

The shell pot 25 includes a protrusion 29. The protrusion 29 extends substantially perpendicular relative to a base surface 30 of the shell pot 25. Alternatively, the shell pot 25 may have a recess on the base surface 30, as illustrated in FIG. 4. The protrusion 29 enters the aperture 26 and engages with the magnet 23. The protrusion 29 has a width W2, which also is substantially identical to or slightly smaller than the diameter d1. This allows the protrusion 29 to accurately locate into the aperture 26 to mechanically center the armature, the tolerance required is determined by the specific application. The width W1 may be substantially identical to the width W2. Like the nub 28, a height h2 of the protrusion 29 may be determined in relation to the length L1.

As noted above, the depth L1 is to prevent a magnetic short circuit. When the magnet 23 generates magnetic flux, the armature core 24 may provide a path for the magnetic flux to pass. The armature core 24 may be made from material that has good conductivity of the magnetic flux such as steel or iron. Surroundings of the armature core 24 such as air may be somewhat more resistant to the magnetic flux. Air space corresponding to the length L1 may provide resistance to the flow of the magnetic flux. As a result of this resistance, the magnetic circuit formed by the magnet 23, the armature core 24, the shell pot 25 and, maybe, other elements will reduce losses due to the short circuit. The diameter d1, the length L1, the width w1, and the width w2 may vary depending on the size of the magnet 23, the thickness of the armature core 24, etc.

The magnet system 22 shown in FIG. 3 has the solid armature core 24 in which a passageway 31 is formed. The passageway 31 also penetrates into the shell pot 25 and may extend to the lower surface of the shell pot 25. In the passageway 31 a shaft 32 made from non-magnetic material such as, e.g., brass, aluminum, stainless steel or plastic is inserted. The shaft 32 is secured on its one end to the shell pot 25 and extends on the other end beyond the upper surface of the armature core 24 where a push-on fastener 33 is pushed onto the shaft 32 by applying of compressive force to magnet 23 and armature core 12 with fastener 33 and shell pot 25. In the present example, the aperture 26 has a diameter larger than the passageway 31 in the armature core 24 and the shell pot 25. Furthermore, the passageway 31 in the armature core 24 may have a larger diameter than it has in the shell pot 25. The diameter of the passageway in the shell pot 25 may be slightly larger than the diameter of the shaft 32 so that the shaft 32 may be press fit into the passageway 31 of the shell pot 25.

In the magnet structure 22, the protrusion 29 concentrically secures the magnet 23 at the center of the shell pot 25 and the nub 28 may secure the armature core 24 and the magnet 23. As a result, the magnet 23, the armature core 24 and the shell pot 25 may internally interlock with one another such that they are concentrically positioned. Alternatively, the protrusion 29, the aperture 26 and the nub 28 may interlock at an off-center position. Additionally, two or more protrusions and nubs are possible.

Adhesives need not be used to secure positioning of the magnet 23, the armature core 24 and the shell pot 25 in the magnet system 22. The interlocking mechanism with the nub 28, the aperture 26 and the protrusion 29 in connection with the shaft 32 and the fastener 33 may permit stable three-dimensional positioning of the magnet 23 to the armature core 24 and the shell pot 25. Additionally, adhesive or similar may be used to avoid a circular movement of the magnet 23 or the armature core 24 around the shaft 32. Unlike adhesives, the interlocking structure is not affected by temperature fluctuation. Further, the interlocking structure may reduce labor costs and associated assembly complexity.

FIG. 4 illustrates a second example of a magnet system 34 for a single magnet type. The magnet system 34 with an interlocking magnet structure includes a magnet 35, an armature core 36 and a shell pot 37. In the magnet system 34, interlocking may occur among the shell pot 37, the magnet 35 and the armature core 36 with a recess 38 of the shell pot 37 and a flange 39 of the armature core 36. The magnet 35 and the armature core 36 have a disc shape but are not limited thereto. The shell pot 37 includes a recess 38 concentrically disposed in the shell pot and formed to accommodate a portion of the magnet 35. The recess 38 may have a diameter that is substantially identical to the diameter of the magnet 35. The shape of the recess 38 may vary depending on the shape of the magnet 35 and/or the armature core 36. The depth of the recess 38 may be determined to sufficiently hold the position of the magnet 35. In the magnet system 34, the magnet 35 may be centrally positioned within the recess 38. The magnet 35 may be placed in the recess 38 such that it is centered by the shell pot 37. The recess 38 has a magnet mounting zone which is shaped and sized to allow a bottom surface of the magnet 35 to be positioned.

The armature core 36 is contiguously mounted on the magnet 35. The armature core 36 has a body member 40 and the flange 39 extending from the body member 40. The armature core 36 has a disc shape in this example. The flange 39 may be radially formed at a circumferential edge of the body member 40 to surround a peripheral edge of the magnet 35 and extend toward the shell pot 37. The flange 39 radially secures the position of the armature core 36 relative to the magnet 35. The length that the flange 39 extends from the body member 40 toward the shell pot 37 may vary depending on the size of the magnet 35 and the strength of the magnetic flux generated by the magnet 35 as already noted above with reference to FIGS. 1 and 3. In any case, the flange 39 should not reach a base surface 41 and the recess 38 of the shell pot 37 to avoid a magnetic short circuit.

In the magnet system 34 shown in FIG. 4, a passageway 42 with various suitable diameters (or uniform diameter) is formed in the solid armature core 36, the magnet 35 and the shell pot 37. In the passageway 42 a shaft 43 made from non-magnetic material such as, e.g., brass, aluminum, stainless steel or plastic is inserted. The shaft 32 is secured on its one end to the shell pot 37, e.g., by forging, pressing, riveting, welding, soldering, gluing etc., and extends on the other end beyond the upper surface of the armature core 36 where a push-on fastener 44 is pushed on the shaft 32 such that compressive force is applied to magnet 35 and armature core 36 by fastener 44 and shell pot 37. A passageway 45 formed in the shaft 22 along its longitudinal axis may help to dissipate the heat or ease assembling.

FIG. 5 illustrates a second example of an interlocking magnet system 46 for a double magnet type. The magnet structure 46 includes a magnet 47, a magnet 48, an armature core 50 and a shell pot 51. The magnets 47 and 48 have apertures 53 and 58 at their center, respectively. The magnets 47 and 48 have a disc shape or may have any other shape. The armature core 50 has a cross shape in its cross sectional view that extends horizontally and vertically relative to the magnets 47 and 48, as shown in FIG. 5. The armature core 50 has two members intersecting with each other perpendicularly. To that end, the armature core 50 includes an extension member 52, an extension member 54 forming one of the members, an extension member 55 and an extension member 56 forming the other members. Flanges 49 and 57 are provided at a peripheral edge of the armature core 50 to further secure the magnets 47 and 48. Alternatively, flanges 49 and 57 may be omitted. The shell pot 51 is formed to include an aperture 61 at the center and a plain top surface 62 at the bottom on which magnet 47 rests.

The extension member 52 may extend through the aperture 53 of the first magnet 47 or may be press fit into the aperture 61 of the shell pot 51. Alternatively, the extension member 52 may extend through the aperture 61 and be secured by a push-on-fastener 59 as shown in FIG. 5. Through the extension members 55 and 56 a compression force is applied to the magnet 47 downwardly. As a result, the magnet 47 remains centrally positioned. The extension member 54 extends through the aperture 58. At a top surface of the magnet 48, the extension member 54 is secured by a push-on fastener 60. The push-on fastener 60 secures the second magnet 48 in place.

In FIG. 5, the vertical extensions such as the extension 52 and the extension 54 have a diameter smaller than that of the horizontal extensions such as the extensions 55 and 56. For instance, the diameter of the vertical extensions may be about a quarter of the thickness of the horizontal extensions. The smaller diameter of the vertical extensions may increase resistance in a path through which the magnetic flux from the magnets 47 and 48 travels. As a result, the structure of magnet system 46 should not experience a significant magnetic short circuit.

FIG. 6 illustrates a third example of an interlocking magnet system 63 for a double magnet type. The magnet structure 63 includes a magnet 64, a magnet 65, an armature core 66, a shell pot 67, a shaft 75 and a push-on fastener 68. The magnets 64 and 65 have the respective apertures 69 and 70 at their center. Alternatively, only one magnet 64 may be provided and the motor 63 may be a single magnet type. The armature core 66 is formed with an aperture 71. The armature core 66 is disposed between the magnets 64 and 65. The shell pot 67 may have an opening 72 that starts from a base surface 73 to a bottom surface 74. The apertures 69 70, 71 and the opening 72 may be formed to accommodate the shaft 75.

The shaft 75 is made from nonmagnetic material e.g. brass, aluminum, stainless steel or plastic. The shaft 75 is, in this example, a rivet that includes a head member 76, and a body member 77. Accordingly, upon engagement with the magnet 65, a portion of the body member 77 is disposed above the top surface of the magnet 65 as illustrated in FIG. 6. The body member 77 may have a cylindrical shape. The body member 77 penetrates through the apertures 70, 71 and 69. The shape of the shaft 75 in FIG. 6 is only exemplary and various other shapes capable of interlocking at least one magnet with a shell pot and an armature core are possible.

As the shaft 75 extends through the apertures 69, 70 and 71 and the opening 72, it engages with the magnets 64 and 65, the armature core 66 and the shell pot 67. The magnets 64 and 65 are centrally secured to the shell pot 67 with the shaft 75. The armature core 66 also may be secured between the two magnets 64 and 65 with the shaft 75. The push-on fastener 68 attached to the shaft 75 also may apply pressure to the top surface of the magnet 65, thereby further securing the magnet 65. Due to being interlocked with the shaft 75 and the fastener 68, the magnets 64 and 65 may not be shifted from the central axis of magnet system 63.

The shaft 75 is inserted into the aligned apertures 69, 70 and 71. The head member 76 is inserted into the opening 72. The fastener 68 may not be pushed on until other parts of the shaft 75 fully engage with the magnets 64 and 65 and the armature core 66. After full engagement, the fastener 68 may be pushed on in one assembly step with a tool that applies a certain amount of pressure to the fastener 68 at the top of the shaft 75. The shaft 75 firmly secures the positioning of the structure of the magnet system 63, regardless of its working environment.

The shaft 75 may be made from diamagnetic or ferromagnetic material, e.g., steel, if the diameter of the shaft 75 is much smaller than the diameter of the magnets 64, 65 and the armature core 66. The smaller diameter of the vertical extensions of the shaft 75 may increase resistance in the path along which the magnetic flux from the magnets 64 and 65 travel. As a result, the structure of magnet system 46 should not experience a significant magnetic short circuit.

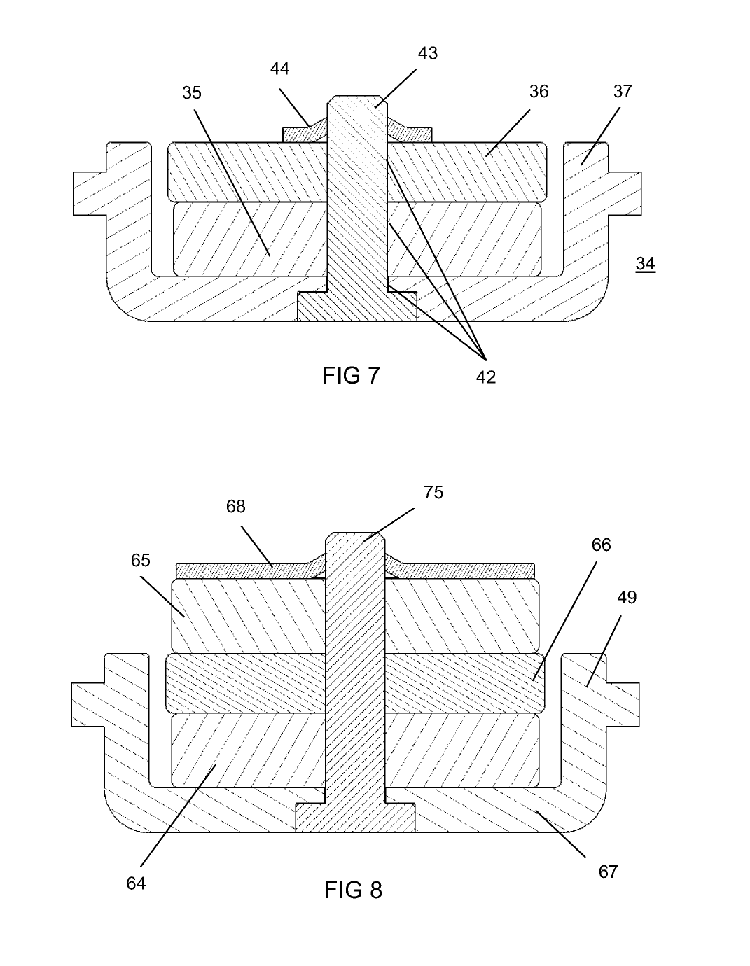

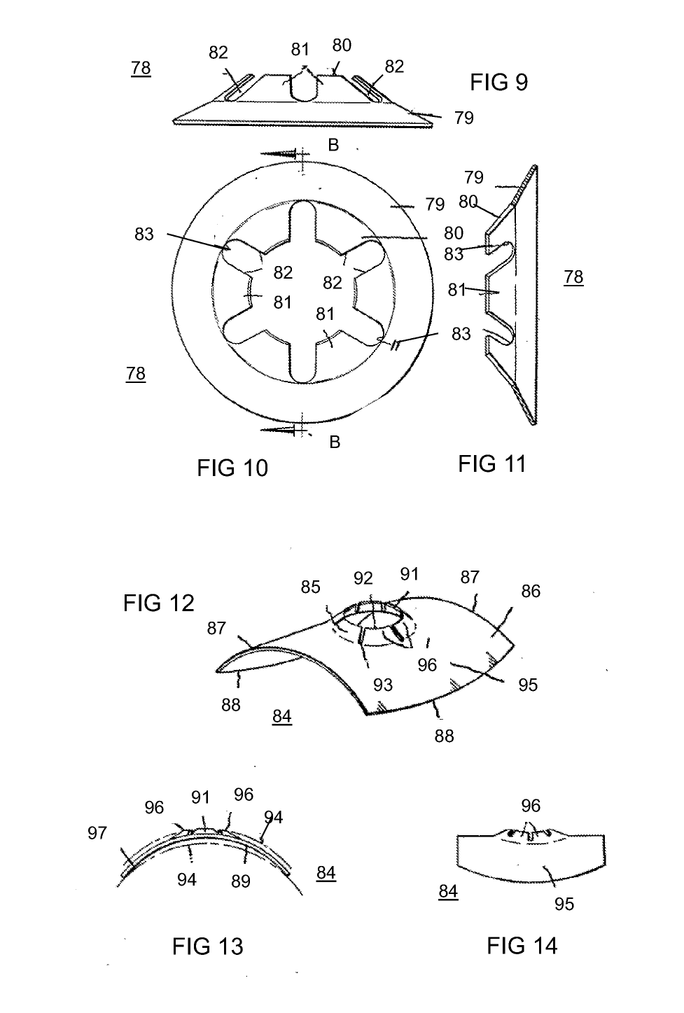

FIG. 7 illustrates a cross-sectional view of an alternative embodiment of the single-magnet type interlocking magnet system of FIG. 4. In the magnet system 34 shown in FIG. 7, the passageway 42 with various suitable diameters is formed in the solid armature core 36, the magnet 35 and the shell pot 37. In the passageway 42 the shaft 43 made from non-magnetic material such as, e.g., brass, aluminum, stainless steel or plastic is inserted. The shaft 43 has on its one end a head member with increased diameter to interact with the push-on fastener 44 and may be secured to the shell pot 37, e.g., by forging, pressing, riveting, welding, soldering, gluing etc. if necessary. The shaft 43 extends on the other end beyond the upper surface of the armature core 36 where the push-on fastener 44 is pushed on the shaft 43 such that compressive force is applied to magnet 35 and armature core 36 by fastener 44 and shell pot 37. The push-on fastener 44 has a reduced size and may be of the type described below with reference to FIGS. 9-23. As can be seen, the armature core 36 has no nubs and the shell pot 37 has no recess so that magnet 35 and armature core 36 engage directly on the shaft 43.

FIG. 8 illustrates a cross-sectional view of an alternative of the double-magnet type interlocking magnet structure of FIG. 6. The magnet structure 63 shown in FIG. 8 includes the magnet 64, the magnet 65, the armature core 66, the shell pot 67, the shaft 75 and the push-on fastener 68. The magnets 64 and 65 have the respective apertures 69 and 70 at their center. The armature core 66 is formed with an aperture 71. The armature core 66 is disposed between the magnets 64 and 65. The shaft 75 has on its one end a head member with an increased diameter corresponding to the uniform diameter of opening 72 of the shell pot 67. The apertures 69 70, 71 and the opening 72 are formed to accommodate the shaft 75. The push-on fastener 68 has maximum size such as approximately the same diameter as magnet 65, and is of the type described below with reference to FIGS. 9-23. As in the structure shown in FIG. 7, there are no nobs, recesses etc. required for interlocking Magnets 64, 65 and armature core 66 engage directly on the shaft 75.

In FIGS. 9-23 illustrate exemplary push-on fasteners The push-on fasteners are washer-like retaining devices comprising a central aperture and at least one fixture that extends into the aperture in a free state of the device and that fixedly engages with the shaft in the pushed-on state of the device. The at least one fixture may comprise a finger having a tip that extends into the aperture. The fasteners are a kind of pressed washers that apply compression to the magnet system and fix the magnet system at center. In order to control the compression, the push-on fastener may be made from resilient material and/or comprises resilient elements. To increase the magnet system's efficiency, the push-on fastener may be made from soft-magnetic material and may be adapted to be part of a magnetic circuit established by the magnet system, e.g., by making its diameter approximately equal the diameter of the magnet(s).

FIGS. 9, 10 and 11 show a retaining device 78 as a first example for the push-on fastener used in the magnet systems shown in FIGS. 1-8. The retaining device 78 comprises an annular body formed from resilient, soft-magnetic material, e.g., soft-magnetic material spring steel sheet-metal. The body of the retaining device 78 has an unbroken outer annular portion 79 and an inner annular portion 80. In the free form the outer portion 79 and the inner portion 80 are both dished, the dishing being in the same direction and of substantially conoidal form, with the inner portion being dished more than the outer portion. The inner portion 80 is divided into six fingers 81 by angularly spaced radial slots 82 extending from the inner circumference that is the edge of the central opening or hole, of the annular body to the junction with the outer portion 79. The dishing of the inner portion gives the fingers 81 the necessary initial inclination relative to the position of the cylindrical surface which they are to grip. To avoid cracks spreading from the slots 82 their closed ends 83 are rounded and their axes are arranged obliquely to the grain of the sheet-metal. The fingers 81 may be separated merely by slitting the metal between them, instead of by the slots 82. The slits at their radially outer ends may be rounded by terminating in circular holes pierced through the metal so as to avoid incipient cracks.

When the retaining device is pushed on, for example, onto the body member 77 of the rivet-like shaft 75 passing through the magnets 64, 65 and the armature core 66 as shown in FIG. 6, the outer annular portion is flattened against the face of the adjacent component, e.g., magnet 65, and the device not only grips the shaft 75 but also maintains axial pressure on its surface. The retaining device may be applied to and tightened on the shaft 75 by a tubular tool (not shown). The outer portion of the tubular tool at one end, when the retaining device is in contact with the magnet 65 and when pressure is applied to the tool, causes the outer portion of the retaining device to flatten against the top surface of the magnet 65. The continuous outer peripheral edge of the retaining device provides suitable initial engagement with the face of the magnet 65 for flattening the outer portion uniformly and without distortion of the components being retained. The grip afforded on the shaft 75 provides a significant resistance to relative angular movement between the components around the shaft, e.g., of the magnets 64, 65 and armature core 66 disposed around shaft 75. A device as shown in FIGS. 9, 10 and 11 is known from, for example, British patent 1 036 103.

FIGS. 12, 13 and 14 show a retaining device 84 as a second example for the push-on fastener used in the magnet systems shown in FIGS. 1-8. The retaining device 84 is made from stiff spring strip or sheet material shaped to form a generally frustoconically dished central finger portion 85 surrounded by a body portion 86 in which “frustoconical” means “having the shape of a frustum of a cone.” The body portion 86 is part-cylindrically curved and has one pair of straight parallel sides 87 and rounded ends 88. The concave face 89 of the body portion 86 has a slightly smaller radius than the cylindrical surface on which it is to be used. In FIG. 13 the broken line 94 represents the cylindrical surface. The springy nature of the device enables the curved flanks 95 (FIGS. 12 and 14) of the body portion 86 to be flexed outwards under pressure applied to the device radially of the body portion so that the radius of curvature of the concave face 89 of the body portion 86 becomes slightly greater than it is when the device is unstressed and the body portion 86 can seat closely against the cylindrical surface 10. FIG. 13 shows how the ends 88 of the body portion engage the cylindrical surface 94 when the device is initially fitted against but not pressed into full contact with tube cylindrical surface 94. It can readily be seen that when the middle of the arc of the body portion is pushed against the cylindrical surface 94 the body portion is under bending stress.

Fingers 91 and 96 of the finger portion 85 all have their root at the body portion and protrude from the convex face of the body portion 86. In this example there are six fingers 91, 96 but there could be more or less. The fingers 91, 96 taper to arcuate tips 92 and are separated in the body portion by narrow slits 93 which are radial to and equi-angularly spaced around a central aperture defined by the tips 92. The tips 92 of the fingers 91, 96, which could be separated, lie on a notional circle drawn on a notional cylindrical surface 94 (FIG. 13) co-axial with the body portion 86. The inclination of the fingers 91, 96 at their root or junction with the body portion 86 varies. The dihedral angle between the fingers 91, 96 and the adjacent portion of the body portion 86 for the fingers 91 on the straight axis of the body portion is greater than for the fingers 96 on the curved flanks 95 of the body portion 86. A device as shown in FIGS. 12, 13 and 14 is known from, for example, British patent 1 069 893.

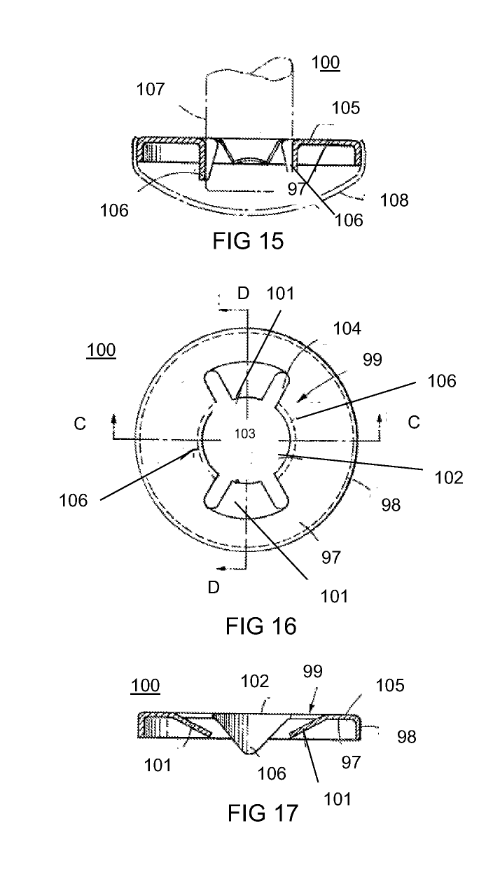

FIGS. 15, 16 and 17 show as a third example a push-on fastener 100 applicable in the magnet systems shown in FIGS. 1-8. The fastener is formed from spring steel sheet and has a continuous annular outer portion 97, with a peripheral flange 98, and an inner portion 99 divided into two locking fingers 101 and two stabilizing fingers 102 extending radially inwards towards an aperture 103 and separated by narrow slots 104, the closed ends of which are rounded. The two locking fingers 101 are diametrically opposite to one another, as are the two stabilizing fingers 102 so that locking fingers 101 and stabilizing fingers 102 alternate. The locking fingers 101 subtend a smaller angle at the center of the aperture 103 than the stabilizing fingers 102 and all grains of the spring steel runs parallel to the line C-C. A back of the outer portion 97 forms a bearing surface 105. The locking fingers 101 from their roots at the junction between the inner and outer portion 99 and 97 are inclined forwards from the plane of the bearing surface and have arcuate tips. The main parts of the stabilizing fingers 102 remain on the plane of the bearing surface 105 as far as the aperture 103 but have extended tips 106 bent forwards and of tapering part-cylindrical shape.

When, as indicated in FIG. 15, the back of the fastener extends over the end of a shaft 107, the locking fingers 101 and stabilizing fingers 102 yield to allow the shaft 107 to enter the aperture 103. The stabilizing fingers 102 guide the fastener and keep its bearing surface at right angles to the shaft axis. The locking fingers 101 resist withdrawal of the fastener in the opposite direction. The fastener may be fitted, as also indicated in FIG. 15, with a domed cap 108 the free edge of which is closed over the back edge of the flange 98. A device as shown in FIGS. 15, 16 and 17 is known from, for example, British patent 1 573 624.

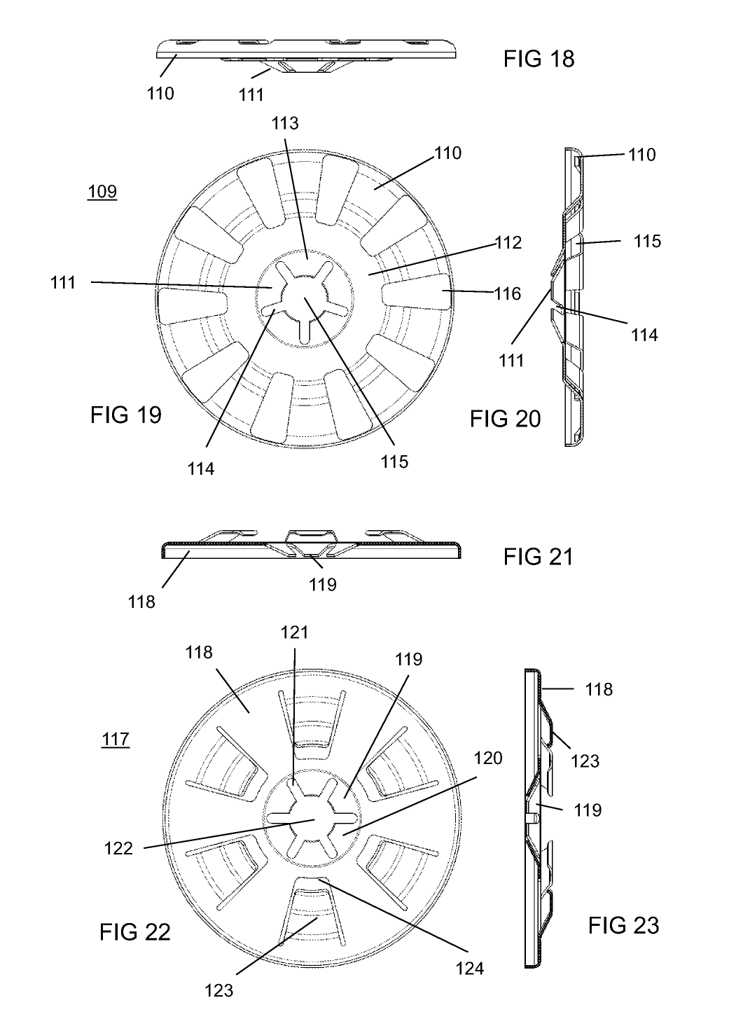

FIGS. 18, 19 and 20 show an exemplary retaining device 109, e.g., for use as a push-on fastener 68 in the magnet system shown in FIG. 8 (or the magnet systems of FIGS. 1-7). The retaining device 109 includes a washer-like annular body formed from, e.g., spring steel sheet-metal. The body of the retaining device 109 has an outer annular portion 110, an inner annular portion 111 and an unbroken intermediate portion 112 located between inner and outer portions 110, 111. The inner portion 111 is dished, the dishing being of substantially conoidal form. The inner portion 111 is divided into five fingers 113 by angularly spaced radial slots 114 extending from the inner circumference that is the edge of a central opening or hole 115, of the annular body to the junction with the intermediate portion 112. The dishing of the inner portion 111 gives the fingers 113 the necessary initial inclination relative to the position of the cylindrical surface which they are to grip. To avoid cracks spreading from the slots 114 their closed ends may be rounded and their axes may be arranged obliquely to the grain of the sheet-metal. The fingers 1113 may be separated merely by slitting the metal between them, instead of by the slots 114. The outer annular portion 110 has a multiplicity of openings 116 extending from the outer circumference of the retaining device 109 that is the outer edge of the annular outer portion 110 to the junction with the intermediate portion 112.

When the retaining device 109 is pushed on, for example, onto the body member of the shaft 75 passing through the magnets 64, 65 and the armature core 66 as shown in FIG. 8, the outer annular portion is flattened against the face of the adjacent component, e.g., magnet 65, and the device not only grips the shaft 75 but also maintains axial pressure on its surface. The retaining device may be applied to and tightened on the shaft 75 by a tubular tool (not shown). The grip afforded on the shaft 75 provides a significant resistance to relative angular movement between the components around the shaft, e.g., of the magnets 64, 65 and armature core 66 disposed around shaft 75.

FIGS. 21, 22 and 23 illustrate another exemplary retaining device 117 for use as a push-on fastener in the magnet systems of FIGS. 1-8. The retaining device 117 includes a washer-like annular body formed from, e.g., spring steel sheet-metal. The body of the retaining device 117 has an outer annular portion 118 and an inner annular portion 119. The inner portion 119 is dished, the dishing being of substantially conoidal form. The inner portion 111 is divided into six fingers 120 by angularly spaced radial slots 121 extending from the inner circumference that is the edge of a central opening or hole 122, of the annular body to the junction with the outer portion 118. The closed ends of the slots 114 are rounded. The outer annular portion 118 has a multiplicity of openings 123 with resilient tongue-like spring elements 124 that are integrally connected to the outer annular portion 118 and that extend into the openings 123.

The retaining device may be applied to and tightened on the shaft 75 by a tubular tool (not shown). The outer portion of the tubular tool at one end, when the retaining device is in contact with the magnet 65 and when pressure is applied to the tool, causes the outer portion 118 including the spring elements 124 of the retaining device to flatten against the top surface of the magnet 65. The continuous outer peripheral edge of the retaining device provides suitable initial engagement with the face of the magnet 65 for flattening the outer portion uniformly and without distortion of the components being retained.

The interlocking magnet structures using a shaft-like element and a push-on fastener as described above secure the position of the magnets in the shell pot three-dimensionally by the interlocking of the magnets, the armature core and/or the shell pot. The interlocking mechanism may further involve, for example, mechanical overlapping, insertion, mounting, engagement, etc. Additionally, structures such as the flange, the aperture, the projection, the protrusion, the nub, the recess, etc. may be used. The interlocking structures are stable and resistant to the working environment of the magnet structure be it mobile, outdoor, etc. For instance, a loudspeaker used in vehicles may have a longer life span with the interlocking magnet structure. Whether adhesive is used or not, the interlocking structure is not substantially affected by the working environment and/or conditions of the adhesive.

The position of the magnets may be secured at the center of the motor and should not shift, despite a prolonged use of the magnet structure, the working environment of the magnet structure, etc. As a result, the loudspeakers employing such magnet structures operate properly and have a long lifespan. Further, manufacturing of the interlocking magnet structure is simple and easy and does not require sophisticated processes and/or increased expenses.

The fastener may be part of the magnetic circuit or not, depending on its position in the magnet system and/or on the material from which it is made. Furthermore, the retaining system prevents chipping damage to the magnets. In the illustrated interlocking magnet structure, concentric arrangements are described. Alternatively, the magnet structures may interlock at off-center position(s). Additionally, two or more nubs, protrusions, apertures, etc. are possible and the interlocking members need not be limited to a single shaft, fastener, nub, protrusion, aperture, etc.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A loudspeaker having a magnet system, the magnet system comprising:
a magnet that has a first surface, a second surface and an aperture;
an armature core that has a first surface, a second surface and an aperture and that is mounted on the magnet, where the second surface of the armature core contacts the first surface of the magnet;
a shell pot configured to receive the magnet and the armature core in a hollow interior, where the second surface of the magnet contacts a base surface of the shell pot;
a shaft that interlocks with the magnet, the armature core and the shell pot, that extends through the aligned apertures included in each of the magnet, the armature core and the shell pot, and that is, on one end, mechanically connected to the shell pot; and
a push-on fastener that has an aperture through which the shaft passes and that is secured to the shaft at another end of the shaft such that the push-on fastener applies pressure onto the first surface of the armature core to fixedly position the armature core and the magnet with respect to the shell pot.

2. The loudspeaker of claim 1, further comprising a further magnet that has a first surface, a second surface and an aperture and that is mounted on the armature core; where the first surface of the armature core contacts the second surface of the further magnet;
where the shaft extends also through the aperture of the further magnet; and
where the push-on fastener is secured to the shaft at the one end of the shaft such that the push-on fastener applies pressure onto the first surface of the further magnet to fixedly position the armature core and the magnets with respect to the shell pot.

3. The loudspeaker of claim 2, where the armature core comprises a first flange at a peripheral edge of the armature core, the first flange extending toward the shell pot and at least partially surrounding a peripheral edge of the magnet, and where the armature core comprises a second flange at a peripheral edge of the armature core, the second flange extending toward the push-on fastener and at least partially surrounding a peripheral edge of the further magnet.

4. The loudspeaker of claim 1, where the shaft is made from nonmagnetic material.

5. The loudspeaker of claim 1, where the push-on fastener is a washer-like retaining device comprising a central aperture and at least one fixture that extends into the aperture in a free state of the washer-like retaining device and that fixedly engages with the shaft in the pushed-on state of the washer-like retaining device.

6. The loudspeaker of claim 5, where the push-on fastener comprises resilient elements.

7. The loudspeaker of claim 5, where the at least one fixture comprises a finger having a tip that extends into the aperture.

8. The loudspeaker of claim 5, where the push-on fastener is made from soft-magnetic material.

9. The loudspeaker of claim 8, where the magnet system establishes a magnetic circuit and the push-on fastener is adapted to be part of the magnetic circuit.

10. The loudspeaker of claim 1, where the interlocking mechanism further comprises at least one of mechanical overlapping, insertion, mounting, and engagement.

11. The loudspeaker of claim 1, where the interlocking mechanism further comprises a structure that includes at least one of a flange, aperture, the projection, the protrusion, the nub, the recess.

12. The loudspeaker of claim 1, where the shaft is fixedly secured to the shell pot.

13. The loudspeaker of claim 1, where the shell pot comprises an aperture through which the shaft extends and where another push-on fastener through which the shaft passes is secured to the shaft at the one end of the shaft such that the another push-on fastener applies pressure onto the shell pot.

14. The loudspeaker of claim 1, where an inner portion of the push-on fastener comprises a plurality of fingers spaced from one another and extending from an inner circumference of the aperture.

15. The loudspeaker of claim 14, where the plurality of fingers extend in a direction toward the shaft and away from the magnet.

16. The loudspeaker of claim 1, where the armature core comprises a flange at a peripheral edge of the armature core, the flange extending toward the shell pot and at least partially surrounding a peripheral edge of the magnet.

17. The loudspeaker of claim 1, where the shaft comprises a passageway along a longitudinal axis of the shaft.

18. A method of assembling a magnet system for use with a loudspeaker, comprising:
forming a first aperture in a magnet;
forming a second aperture in an armature core;
forming a third aperture in a base surface of a shell pot;
aligning the first, second and third apertures;
extending a shaft through the aligned first, second and third apertures; and
pushing a push-on fastener onto at least one end of the shaft.

19. The method of claim 18, where, in use of the fastener, fingers of the fastener engage the surface of the shaft entered in the aperture and the fingers lie oblique to the said surface of the shaft, and when the fastener is pushed along the shaft in the direction in which the fingers trail arcuate edges of the fingers slide along the shaft but when pushed in the opposite direction the fingers grip the shaft and resist relative movement.

20. A method of assembling a magnet system for use with a loudspeaker, comprising:
connecting one end of a shaft to a shell pot;
forming a first aperture in a magnet;
forming a second aperture in an armature core;
extending the shaft through the first and second apertures; and
pushing a push-on fastener onto the shaft at another end of the shaft.
